(19) United States
(12) Patent Application Publication
(10) Pub. No.: US 2016/0131309 A1
(43) Pub. Date: May 12, 2016

(54) BULB CUP STRUCTURE AND LED BULB COMPRISING THE SAME

(71) Applicant: KUNSHAN NANO NEW MATERIAL TECHNOLOGY CO.,LTD., Jiangsu (CN)

(72) Inventor: Hung-Tu LU, Taipei City (TW)

(21) Appl. No.: 14/593,769

(22) Filed: Jan. 9, 2015

(30) Foreign Application Priority Data
Nov. 10, 2014 (TW) 103219898

(51) Int. Cl. F21K 99/00; F21V 29/15; F21V 15/01

(52) U.S. Cl. CPC F21K 9/13; F21V 15/01; F21V 29/15; F21Y 2101/02

(57) ABSTRACT

A bulb cup structure and an LED bulb comprising the same are provided. The bulb cup structure includes a main body of a bulb cup being a hollow housing and both ends having openings of different widths. One part of the main body of the bulb cup is shaped as a cup-shaped housing and another part of the main body of the bulb cup is shaped as a cylindrical housing. Wherein a cross-sectional area of the cup-shaped housing gradually narrows down from one end to the other end, and the cylindrical housing has a fixed-width and the fixed-width matches to the narrowest cross-sectional area of the cup-shaped housing, and outer edge of the cylindrical housing includes a lamp holder connecting part. The bulb cup structure is applicable to simplifying components of LED bulbs and manufacturing process to promote the productive efficiency and yield.

### CROSS-REFERENCE TO RELATED APPLICATION

This application claims priority from Taiwan Patent Application No. 103219898, filed on Nov. 10, 2014, in the Taiwan Intellectual Property Office, the content of which are hereby incorporated by reference in their entirety for all purposes.

### BACKGROUND OF THE INVENTION

1. Field of the Invention

This application relates to a bulb cup structure and a light-emitting diode (LED) bulb comprising the same, and more particularly, to an integrated bulb cup structure and an LED bulb comprising the same.

2. Description of the Related Art

Recently, as the technique of light-emitting component has been developing, illumination apparatuses such as conventional bulbs and fluorescent bulbs and so on are replaced by emerging illumination devices gradually. The LED, which has advantages of lower power consumption and longer service life and so on, has become a lighting technique that attracts close attention. Compared with the known bulbs used in traditional illumination, the research and development on the current LED bulbs are mainly criticized for its manufacturing cost. The cost of disposing new LED illumination devices or replacing conventional illumination devices with new LED illumination devices and the price of the LED bulbs are both higher than the conventional illumination apparatuses, such that the desire for the usage is reduced greatly. Therefore, how to reduce the cost plays a key role on promoting popularization rate of LED lighting technique.

The current LED bulbs on the market include mostly structures of bulb cup and bulb head which are manufactured respectively while being produced. The bulb cup and the bulb head are respectively wrapped by the injection manufacturing process. After the separate process, the bulb cup and the bulb head are assembled together to form the LED bulb. Nonetheless, more components are required and the production procedure thereof is more complicated. The extra manufacture apparatus for the bulb head is also necessary, and the defective units caused in the process of production can't be reworked. Consequently, it may result in the waste of the materials, and the manufacturing cost to the product is increased insidiously.

As a result, the inventor of the present invention has been mulling the technical problem over and hence designs an LED bulb structure which aims at improving the current technique so as to boost the industrial applicability.

### SUMMARY OF THE INVENTION

Inasmuch as the aforementioned technical problems, one purpose of the present invention is to provide an LED bulb structure to replace structures of bulb cup and bulb head of the conventional LED bulbs with innovative bulb cup structure so as to decrease the steps of the manufacturing process and effectively promote the manufacturing efficiency and yield, as well as further to reduce the manufacturing cost of the LED bulbs.

According to one purpose of the present invention, a bulb cup structure is provided which may include a main body of a bulb cup being a hollow housing and both ends having openings of different widths. One part of the main body of the bulb cup being shaped as a cup-shaped housing and another part of the main body of the bulb cup being shaped as a cylindrical housing Wherein, a cross-sectional area of the cup-shaped housing may gradually narrow down from one end to another end, the cylindrical housing may have a fixed-width and the fixed-width may match to the narrowest cross-sectional area of the cup-shaped housing, and an outer edge of the cylindrical housing may include a lamp holder connecting part.

Preferably, the main body of the bulb cup may include metallic or conductive materials.

Preferably, the main body of the bulb cup may be made by a stamping and spinning manufacturing process.

Preferably, an outer part of the cup-shaped housing may be covered a heat insulation layer and an inner edge of the cylindrical housing may include an insulating layer.

Preferably, the heat insulation layer and the insulating layer may include the same plastic material.

Preferably, the heat insulation layer and the insulating layer may be made through wrapping by injection manufacturing process simultaneously.

Preferably, the lamp holder connecting part may include a screwed structure corresponding to a lamp holder.

According to another purpose of the present invention, an LED bulb is further provided which may include a main body of a bulb cup being a hollow housing, and both ends having openings of different widths. An accommodating space formed therein, and one part of the main body of the bulb cup may be shaped as a cup-shaped housing and another part of the main body of the bulb cup may be shaped as a cylindrical housing. Wherein, a cross-sectional area of cup-shaped housing may gradually narrow down from one end to another end, the cylindrical housing may have a fixed-width and the fixed-width may match to the narrowest cross-sectional area of the cup-shaped housing, an outer edge of the cylindrical housing may include a lamp holder connecting part, and an inner edge of the cylindrical housing may include an insulating layer, an LED light-emitting module may be disposed in the accommodating space, and a bulb shade may be connected to one end of the main body of the bulb cup to cover the opening of the main body of the bulb cup and the LED light-emitting module.

Preferably, the LED light-emitting module may include an LED light emission source and a driving circuit.

Preferably, the main body of the bulb cup may include metallic or conductive materials.

Preferably, the main body of the bulb cup may be made by a stamping and spinning manufacturing process.

Preferably, the heat insulation layer and the insulating layer may include the same plastic material.

Preferably, the heat insulation layer and the insulating layer may be made through wrapping by injection manufacturing process simultaneously.

Preferably, the lamp holder connecting part may include a screwed structure corresponding to a lamp holder.

As described above, a bulb cup structure of the present invention and an LED bulb comprising the same in accordance with the present invention may have one or more advantages as follows.

(1) The bulb cup structure and the LED bulb comprising the same are to use an integrated bulb cup structure to replace the conventional one, as well as to simplify the product's components and manufacturing process thereof.

(2) The bulb cup structure and the LED bulb comprising the same are able to increase the possibility to rework the work in process and to raise the material's utilization rate so as to decrease the waste in the process of production.

(3) The bulb cup structure and the LED bulb comprising the same are capable of forming a single bulb cup structure or forming heat insulation layer and insulating layer simultaneously so as to decrease the needs for production apparatus, and as a result to promote the flexibility of manufacturing process.

### BRIEF DESCRIPTION OF THE DRAWINGS

FIG. 1 is a schematic diagram of a bulb cup structure in accordance with an embodiment of the present invention.

FIG. 2 is a schematic diagram of a bulb cup structure in accordance with another embodiment of the present invention.

FIG. 3 is a cross-sectional diagram of a bulb cup structure in accordance with another embodiment of the present invention.

FIG. 4 is a schematic diagram of an LED bulb in accordance with an embodiment of the present invention.

FIG. 5 is a cross-sectional diagram of an LED bulb in accordance with an embodiment of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

The drawings and description are to be regarded as illustrative in nature and not restrictive. Similar reference numerals designate similar elements throughout the specification.

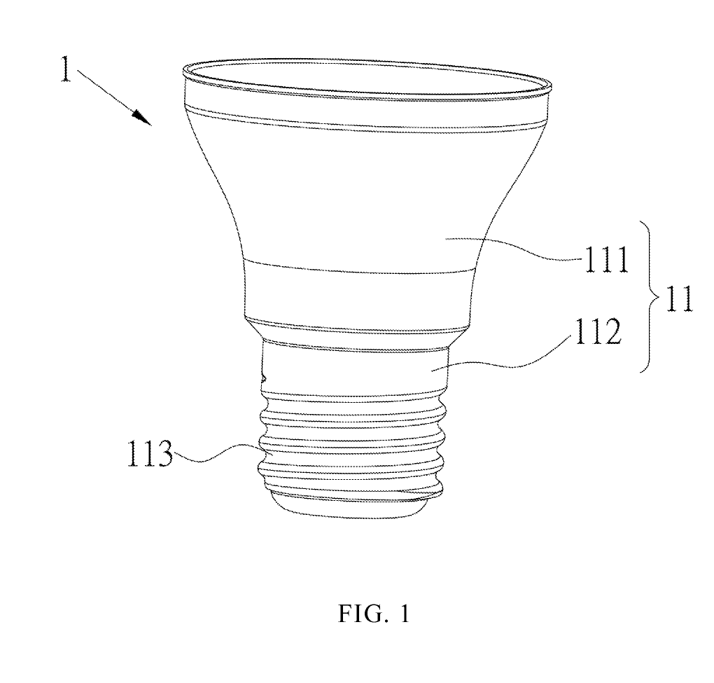

Please refer to FIG. 1 which is a schematic diagram of a bulb cup structure in accordance with an embodiment of the present invention. As shown in the figure, a bulb cup structure 1 may be a main body of a bulb cup 11 with an upper part and a bottom part. The upper part of the main body of the bulb cup 11 is wider than the bottom part of the main body of the bulb cup 11. The main body of the bulb cup 11 is a hollow housing and is formed with an inner space for arranging an LED light-emitting module, and both ends respectively have openings of different widths. The upper part of the main body of the bulb cup 11 is a cup-shaped housing 111 and the width of the opening gradually reduces from top to bottom. A wider opening is suitable for disposing the related substrate and the light-emitting components of the LED module. The bottom of the cup-shaped housing 111 is a cylindrical housing 112 which has an opening in the lowermost end as well. The outer edge of the cylindrical housing 112 is disposed with a screwed structure 113 corresponding to a necessary connecting part for a lamp holder. For example, the screwed structure 113 is rotated directly to contact and to be fixed in the lamp holder.

In the embodiment, the main body of the bulb cup may include metallic or conductive materials such as alumina or aluminum alloy. That is, the integrated main body of the bulb cup 11 is formed of an aluminum plate by conducting the stamping and spinning processes. Among these, the main body of the bulb cup 11 is a single component. Compared with the conventional lamp bulbs, the bulb cup and the bulb head are separated pieces and are respectively processed through the stamping and spinning processes. Thus, an assembly procedure for the two items is necessary. A single bulb cup structure in accordance with the present invention is able to shorten and simplify the manufacturing process so as to promote the productive efficiency.

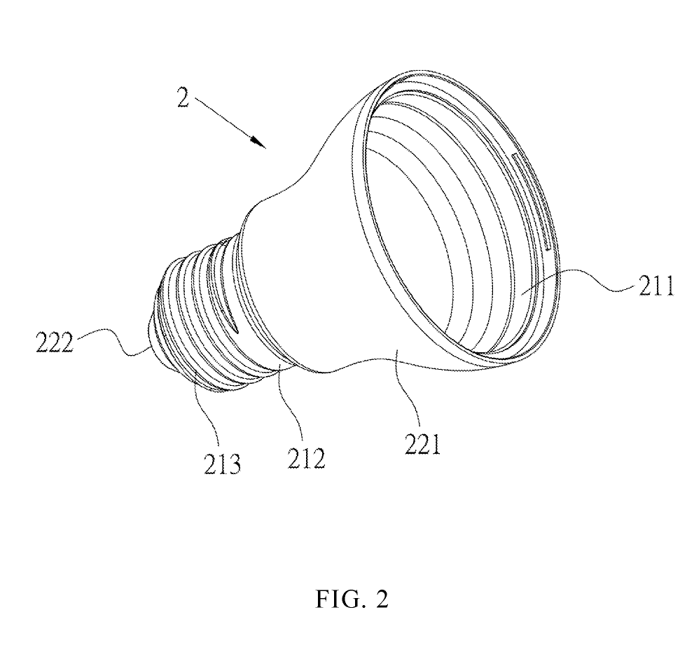

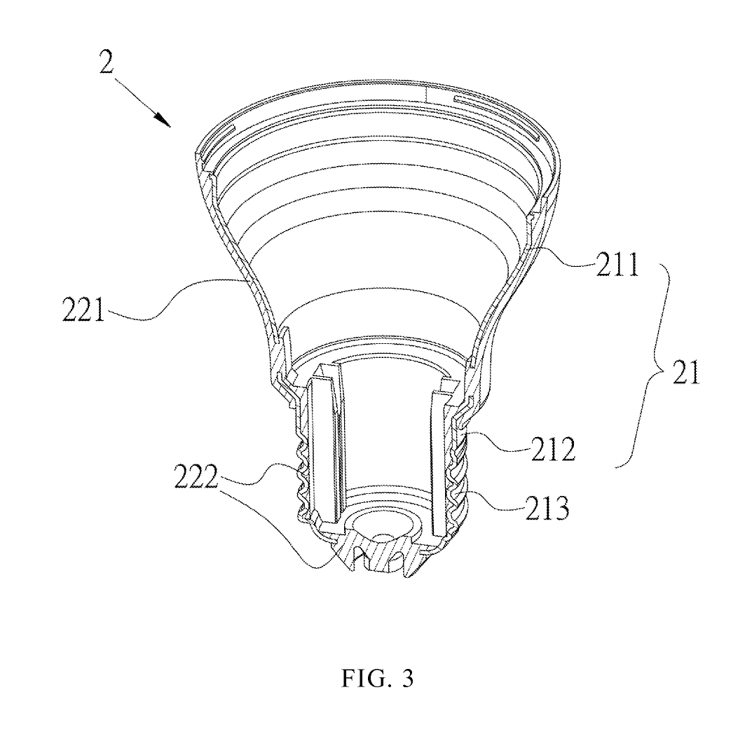

Please refer to FIG. 2 and FIG. 3 together which are respectively a schematic diagram and a cross-sectional diagram of another embodiment in accordance with the present invention. As shown in the figures, a bulb cup structure 2 includes a main body of the bulb cup 21 which is similar to the aforementioned embodiment. The main body of the bulb cup 21 is a hollow housing and both ends have openings. The main body of the bulb cup 21 includes a cup-shaped housing 211 and a cylindrical housing 212, and the outer edge of the cylindrical housing 212 includes a screwed structure 213. The cup-shaped housing 211 and the cylindrical housing 212 are combined together as a single component which is made of an aluminum plate by conducting the stamping and spinning processes. In the present embodiment, however, the bulb cup structure 2 further includes a heat insulation layer 221 covering the cup-shaped housing 211 and an insulating layer 222 formed in the inner edge of the cylindrical housing 212. The heat insulation layer 221 covers the whole cup-shaped housing 211. The main purpose is that the heat energy generated by the modules such as the light-emitting components or driving circuits and transmitted to the metallic housing can be blocked by the heat insulation layer. The insulating layer 222 formed in the inner edge of the cylindrical housing 212 is served as an insulating structure between the conductive housing and the arranged substrate. The insulating layer 222 formed in the inner edge of the cylindrical housing 212 may be formed as a structure protruding outside the opening of the cylindrical housing 212 according to the practical requirement.

As can be seen in the cross-sectional diagram of FIG. 3, the heat insulation layer 221 and the insulating layer 222 respectively cover the outer side and inner side of the main body of the bulb cup, and are both made of plastic material. Therefore, the plastic particles may be injected to cover the outer part of the cup-shaped housing 221 and the inner part of the cylindrical housing 212 by means of wrapping by injection manufacturing process so as to form and then accomplish the disposition of the heat insulation layer 221 and the insulating layer 222 in the process of production. Compared with the conventional manufacturing process, the bulb cup and the bulb head are produced separately and then respectively processed wrapping by injection manufacturing process, and afterwards, are assembled respectively to accomplish the product. A bulb cup structure in accordance with the present invention is made only by a single injection molding without extra assembling procedures.

Additionally, the requirement for the manufacturing apparatus and the molds are also reduced so as to increase the flexibility of the manufacturing process.

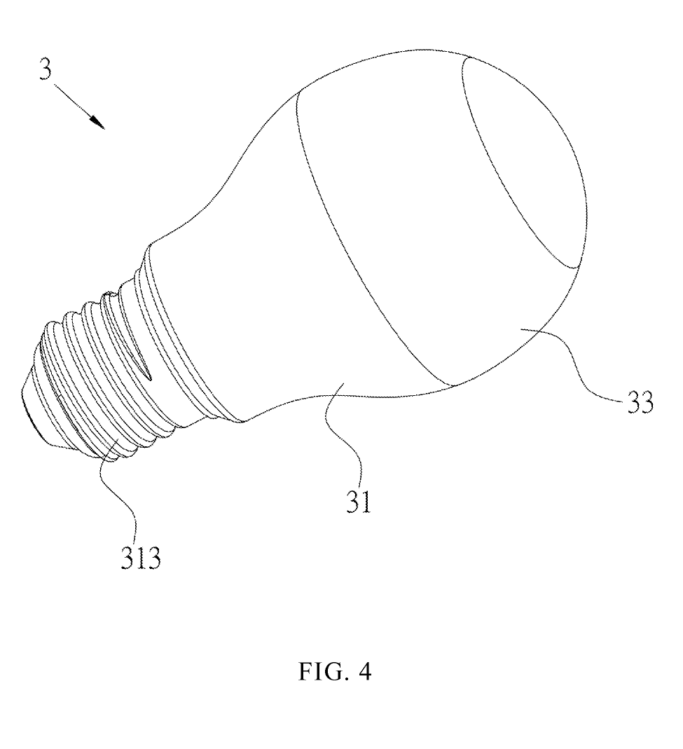

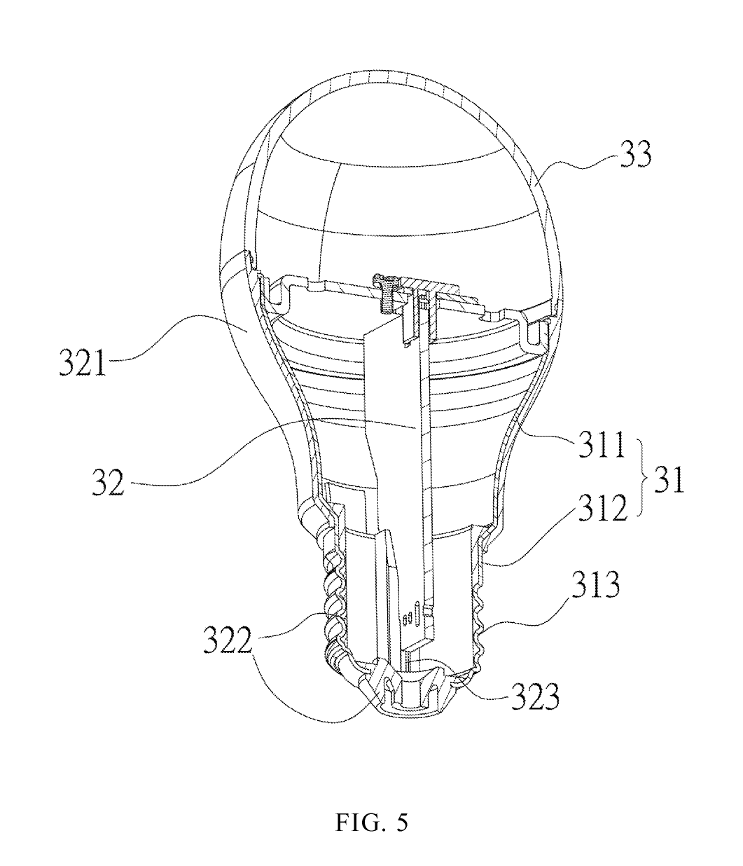

Please refer to FIG. 4 and FIG. 5 together which are respectively a schematic diagram and a cross-sectional diagram of an LED bulb in accordance with an embodiment of the present invention. As shown in the figures, an LED bulb 3 includes a main body of a bulb cup 31, an LED light-emitting module 32 and a bulb shade 33. A screwed structure 313 at the end of the main body of the bulb cup 31 is provided. The LED bulb 3 is disposed corresponding to a lamp holder such that the LED light-emitting module 32 is powered and driven by the lamp holder to emit light and perform illuminating. In the structure, the main body of the bulb cup 31 includes a cup-shaped housing 311 and a cylindrical housing 312, and an accommodating space is formed therein for serving as a position where the LED light-emitting module 32 is disposed. Moreover, the outer edge of the cup-shaped housing 311 is covered with a heat insulation layer 321 and the inner edge of the cylindrical housing 312 includes an insulating layer 322. The heat insulation layer 321 and the insulating layer 322 are formed simultaneously by injection molding by means of plastic materials. Besides, when forming the inner insulating layer 322, a corresponding module may be designed and grooves 323 may be formed to dispose the LED light-emitting module 32 in the accommodating space to enable the circuit substrate of the LED light-emitting module 32 being clipped in the grooves 323 so as to be fixed in a preset position. The structure of the grooves 323 used to fix the circuit substrate may be adjusted according to the size or the shape of the circuit substrate, and is not limited to that as shown in FIG. 5.

Apart from the bulb cup structure which is similar to the preceding embodiments, the LED bulb 3 further includes the LED light-emitting module 32 including LED light-emitting components and the circuit substrate. The driving circuit elements on the circuit substrate drive the LED light-emitting components to emit light to generate the necessary luminance. The bulb shade 33 is disposed at one side of the main body of the bulb cup 31, and covers the opening of the main body of the bulb cup 31 and the LED light-emitting module 32. The bulb shade 33 may be made of plastic material which is characterized of light transmission. Moreover, the bulb shade 33 may be fixed to the main body of bulb cup 31 by means of adhesion, and the inner accommodating space disposed in the LED light-emitting module 32 is thereby sealed to avoid the LED light-emitting components or the driving circuit elements being affected by external environmental factors, such as moisture and oxygen and so on.

In accordance with different amounts of the LED light-emitting components or diversity of structure thereof, the LED light-emitting module 32 may have various arrangements. For example, the end of the opening of the main body of the bulb cup 31 may be disposed with the metal heat sink to cover the circuit substrate to discharge the heat caused by the circuit substrate or the LED light-emitting components so as to avoid the LED light-emitting components or circuits being damaged. In addition, a connecting component may be disposed to connect the circuit substrate with the conductive main body of the bulb cup according to the practical needs so as to supply necessary electric power for the driving circuit while being disposed to the lamp holder.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A bulb cup structure, comprising:
a main body of a bulb cup being a hollow housing and both ends having openings of different widths, and one part of the main body of the bulb cup being a cup-shaped housing and another part of the main body of the bulb cup being a cylindrical housing;
wherein a cross-sectional area of the cup-shaped housing gradually narrows down from one end to another end, the cylindrical housing has a fixed-width and the fixed-width matches to the narrowest cross-sectional area of the cup-shaped housing, and an outer edge of the cylindrical housing comprises a lamp holder connecting part.

2. The bulb cup structure of claim 1, wherein the main body of the bulb cup comprises metallic or conductive material.

3. The bulb cup structure of claim 1, wherein the main body of the bulb cup is made by a stamping and spinning manufacturing process.

4. The bulb cup structure of claim 1, wherein an outer part of the cup-shaped housing is covered a heat insulation layer and an inner edge of the cylindrical housing comprises an insulating layer.

5. The bulb cup structure of claim 4, wherein the heat insulation layer and the insulating layer comprise the same plastic material.

6. The bulb cup structure of claim 4, wherein the heat insulation layer and the insulating layer are made through wrapping by injection manufacturing process simultaneously.

7. The bulb cup structure of claim 1, wherein the lamp holder connecting part comprises a screwed structure corresponding to a lamp holder.

8. An LED bulb, comprising:
a main body of a bulb cup being a hollow housing and both ends having openings of different widths, an accommodating space formed therein, and one part of the main body of the bulb cup being shaped as a cup-shaped housing and another part of the main body of the bulb cup being shaped as a cylindrical housing;
wherein a cross-sectional area of the cup-shaped housing gradually narrows down from one end to another end, the cylindrical housing has a fixed-width and the fixed-width matches to the narrowest cross-sectional area of the cup-shaped housing, an outer edge of the cylindrical housing comprises a lamp holder connecting part, and an inner edge of the cylindrical housing comprises an insulating layer;
an LED light-emitting module disposed in the accommodating space; and
a bulb shade connected to one end of the main body of the bulb cup to cover the opening of the main body of the bulb cup and the LED light-emitting module.

9. The LED bulb of claim 8, wherein the LED light-emitting module comprises an LED light emission source and a driving circuit.

10. The LED bulb of claim 8, wherein the main body of the bulb cup comprises metallic or conductive material.

11. The LED bulb of claim 8, wherein the main body of the bulb cup is made by a stamping and spinning manufacturing process.

12. The LED bulb of claim 8, wherein the heat insulation layer and the insulating layer comprise the same plastic material.

13. The LED bulb of claim 8, wherein the heat insulation layer and the insulating layer are made through wrapping by injection manufacturing process simultaneously.

14. The LED bulb of claim 8, wherein the lamp holder connecting part comprises a screwed structure corresponding to a lamp holder.
